(19) United States
(12) Patent Application Publication
(10) Pub. No.: US 2009/0213601 A1
(43) Pub. Date: Aug. 27, 2009

(54) Light Sensor for Broadband Solar and Twilight Function Control

(76) Inventor: Paul E. Clugston, JR., Windham, ME (US)

Correspondence Address: SENSATA TECHNOLOGIES, INC., 529 PLEASANT STREET, MS B-1, ATTLEBORO, MA, 02703, US

(21) Appl. No.: 12/265,773

(22) Filed: Nov. 6, 2008

Related U.S. Application Data
(60) Provisional application No. 61/031,719, filed on Feb. 27, 2008.

(51) Int. Cl. B60Q 1/00

(52) U.S. Cl. 362/464

(57) ABSTRACT

The present invention is directed to a sensor that detects external ambient light energy for automatically controlling vehicle headlights while also detecting solar loading within a vehicle passenger compartment for automatically controlling interior climate. The integrated circuit comprises a signal amplifier and a photodetector adapted for receiving ambient light energy. The integrated circuit produces a solar output signal having a first gain and a twilight output signal having a second gain, such that the spectral response of the sensor is dictated primarily by the spectral response of the photodetector. A transmissive layer covers the sensor, and the neutral density diffuser is disposed between the transmissive layer and the integrated circuit and lacks any pigments that would prevent light energy from reaching the photodetector at an undiminished level of intensity.

### BACKGROUND OF THE INVENTION

1. Field of the Invention

The present invention relates generally to the field of light sensors and more particularly to sensors comprising photodetectors that control both a vehicle's headlights according to detected ambient light conditions and the vehicle's passenger compartment climate according to detected solar load conditions.

2. Discussion of Background Information

Vehicles often incorporate automatic system control features such as those for automatically controlling vehicle headlamps according to varying light conditions and those for automatically controlling climate within an interior passenger space in response to varying levels of light energy entering and heating that space. These automatic features rely on sensors for detecting a perceived intensity of ambient light and for measuring a solar load, i.e. the amount of energy entering and heating a passenger compartment. Traditionally, different types of sensors separately control these twilight and solar functions. For example a CIE sensor producing a control signal that approximates an eye-like response to varying visible wavelengths of light may control headlights well. The Commission Internationale de L'éclairage (CIE) is the international authority on light, illumination, color, and color spaces that developed the CIE 1931 color space chromaticity wavelength diagram. CIE refers herein to photopic response curves that represent human perception of color and luminance. For example, CIE sensors respond to lighting variation and automatically control vehicle headlamps as would a driver perceiving variations in lighting conditions.

In addition to solar sensors, photodiodes sensitive to the longer wavelengths of light responsible for heating a passenger compartment more effectively may detect solar load for controlling temperature. Some sensor manufacturers provide an eye-like, or CIE photopic, response by loading special absorption dyes into a diffuse material surrounding the sensor. Diffusers incorporating green dyes most closely approximate human eye perception of ambient light by modifying the final spectral characteristics of a sensor response curve to match those of a CIE photopic response curve. One major problem with this approach is that such a diffuser drastically reduces the total amount of energy reaching the photodetector. As a direct result of the lower light levels presented to a photodetector, the sensor subsequently must compensate by amplifying signal output to vehicle control systems. This requirement for drastically increased amplification presents inherent sensor manufacturing challenges known to those skilled in the art.

Integrated solar-twilight sensors attempt to combine automatic headlamp and climate control features on a single integrated circuit die that produces separate outputs with separate signal gains corresponding to the respective functions. A sensor integrating the solar and twilight functions generally also incorporates a diffuser dye for producing signal responses corresponding to the eye-like spectral response. This approach, however, gives precedence to the twilight function. As a result, the solar output similarly responds according to an eye-like spectral response, but only at higher light levels. This approach results in less than ideal sensor output performance under some sky conditions or weather conditions. For example, large quantities of visible light exist in bright sun conditions. Localized fog will diffuse that light so that a sensor detects high levels of light and responds by turning on an air conditioner in the passenger compartment because of an erroneously perceived increase of energy entering and heating that interior space.

Solar sensors based on standard silicon photodiodes and phototransistors offer some response across the 350 nm to 1100 nm region of light wavelengths, but they generally provide a peak response in the near infrared (NIR) region of the light spectra, often near 900 nm. NIR wavelengths of light contribute to heating the passenger compartment. As manufacturers continue to improve the windshield designs to attenuate NIR radiation entering the passenger compartment, these solar sensors produce lower and lower output signal levels because they receive less and less light energy from the NIR wavelengths. Some stand-alone solar sensors even rely exclusively on the NIR spectral region for their response, rejecting wavelengths shorter than about 700 nm. For the same reasons, these sensors also produce lower output signal levels if used with the newer windshield designs that block NIR wavelengths from entering and heating the passenger compartment.

For the foregoing reasons, a need exists for an integrated solar and twilight sensor that functions accurately in use with new windshield designs that block NIR and UV radiation. A need exists for the integrated solar and twilight sensor to provide consistent signal responses across a broad range of wavelengths detected at various elevations and under various weather conditions, thereby accurately controlling automotive solar and twilight response systems.

### SUMMARY OF THE INVENTION

The present invention is directed toward a sensor that detects external ambient light energy for automatically controlling vehicle headlights while also detecting solar loading within a vehicle passenger compartment for automatically controlling interior climate according to the amount of light energy entering and heating that space. The sensor comprises an integrated circuit, a transmissive layer and a diffuser.

The integrated circuit comprises a photodetector adapted for receiving ambient light energy and having a solar output signal and a twilight output signal. The solar output signal experiences a first gain and the twilight output signal experiences a second gain, and wherein the spectral response of the sensor is dictated primarily by the spectral response of the photodetector. The transmissive layer covers the sensor while providing no significant spectral filtering of the ambient light energy. The neutral density diffuser is disposed between the transmissive layer and the integrated circuit, wherein the diffuser lacks dyes or pigments for controlling the spectral response of the sensor and wherein the diffuser thereby allows light energy to reach the photodetector at an undiminished level of intensity. The sensor further comprises an integrated signal amplifier for amplifying the twilight output signal.

The present invention is described below in detail according to its preferred embodiments with reference to the following figures.

### BRIEF DESCRIPTION OF THE DRAWINGS

These and other features, aspects, and advantages of the present invention will become better understood with reference to the following description, appended claims, and accompanying drawings where:

FIG. 1 shows the device of the present invention under a load condition.

FIG. 2 shows a cutaway schematic of a side view of the present invention.

FIG. 3 depicts twilight spectral response curves for a variety of sensors including one embodiment of the present invention.

FIG. 4 depicts solar spectral response curves for a variety of sensors including one embodiment of the present invention.

FIG. 5 depicts solar spectral response curves for a variety of sensors including one embodiment of the present invention.

FIG. 6 depicts a schematic cross section of one exemplary embodiment of the present invention.

FIG. 7 depicts a functional signal flow diagram of an exemplary embodiment of the present invention.

FIG. 8 depicts an output diagram of an exemplary embodiment of the present invention.

FIG. 9 depicts a functional signal flow diagram of an embodiment of the present invention.

FIG. 10 depicts an output diagram an embodiment of the present invention.

### DETAILED DESCRIPTION

The present invention is directed to a combined solar-twilight sensor that better matches the spectral transmission of latest windshield design improvements to accurately control automatic use of vehicle headlights and passenger compartment climate control systems. Windshields now attenuate wavelengths of light falling within ultraviolet (UV) and near infrared (NIR) ranges. The sensor of the present invention accurately detects the solar loading experience within a vehicular passenger compartment for automatically controlling climate, while continuing to respond accurately to ambient light conditions for headlight control.

The sensor of the present invention comprises an integrated circuit, interchangeably referred to herein as an Application Specific Integrated Circuit (ASIC). This analog device also comprises an integrated silicon photodiode and a transimpedence amplifier for converting photocurrent on the photodiode to voltage. By design, this light dependent current sink communicates with a vehicle control systems for turning external headlights on and off accurately and for similarly controlling backlighting on an instrument control panel, lighting on entertainment display screens, and/or other interior lighting according to changing ambient light conditions. The ASIC of the present invention also controls temperature control system for maintaining the passenger compartment at a comfortable temperature by accommodating varying solar loads that would otherwise heat a passenger space.

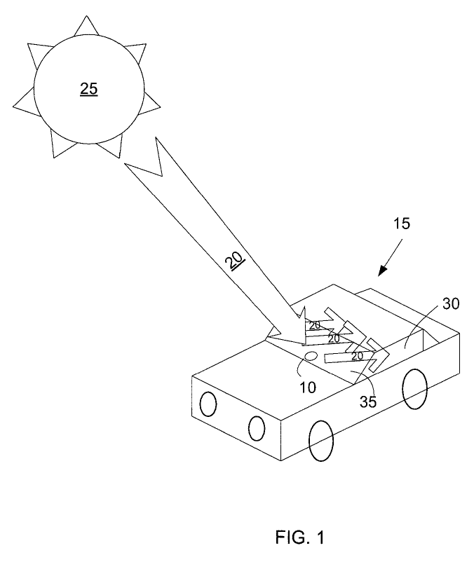

FIG. 1 is a general depiction of the sensor 10 in use within a vehicle 15. Ambient light 20 from an ambient light source 25, here depicted as the sun, enters the passenger compartment 30 through the windshield 35. The sensor 10 is disposed near an instrument panel (not shown) and may be located conveniently on a dashboard just beneath the windshield 35, for example.

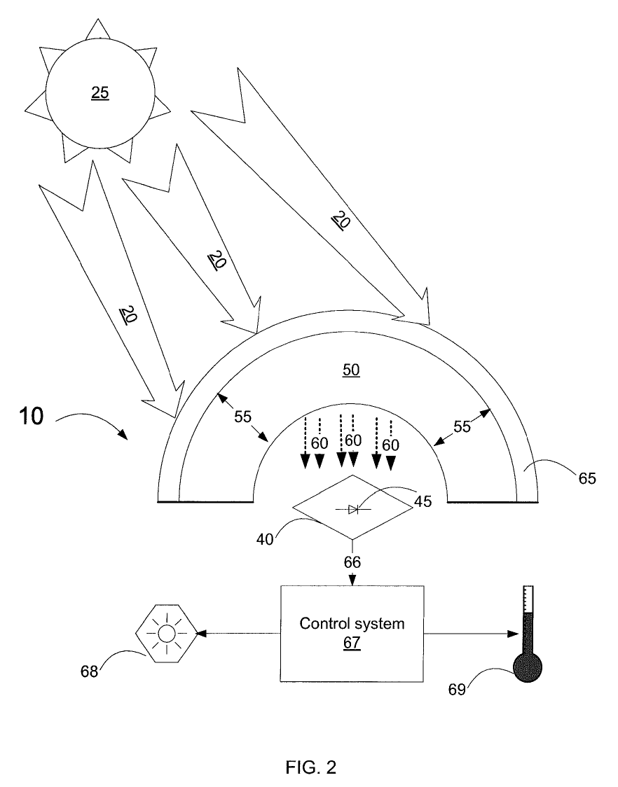

Turning now to FIG. 2 showing a detailed view of the sensor 10, an embodiment of the present invention includes an application specific integrated circuit (ASIC ) 40 that further comprises both a silicon-based integrated epi-photodiode 45 and an integrated signal amplifier (not depicted). Those skilled in the art will understand that they may substitute one or more discrete amplifiers (not shown) in place of or in addition to the integrated signal amplifier.

This embodiment of the sensor 10 comprises a diffuser 50 disposed between the ambient light source 25 and the sensor 10. Here, the diffuser 50 is dome shaped to better diffuse the ambient light 20 approaching the sensor from a wider range of angles. Other diffuser shapes may be preferable under certain conditions. Specifically, in this embodiment, the diffuser 50 is domed shaped and comprises a uniform wall thickness 55. The diffuser further comprises a neutral density material such that the spectral content of the light passing through the diffuser 50 remains unaltered. The process of diffusing the impinging ambient light 20 reduces the amount of diffused light 60 that passes though the diffuser 50 to the ASIC 40. The total light transmission through the diffuser 50 is adjustable by uniformly changing the wall thickness 55 of the diffuser 50. A thinner diffuser 50 will allow more ambient light 20 to pass through to the ASIC 40 as diffused light 60 while a thicker diffuser 50 will transmit less ambient light 20.

In addition to this reduction in light transmission, the diffuser 50 may comprise additional means that further reduce the light transmission as required by a specific application. These additional means include but are not limited to loading the diffuser 50 with pigments or dyes that provide a spectrally neutral reduction in the light transmission. Other methods include placing a separate neutral density transmissive structure 65 over and/or under the diffuser 50. The means of additional light transmission reduction, therefore, may exist as an integral feature of the diffuser 50 or as a separate transmissive structure 65.

Generally, diffusers comprising pigment or dye are produced lighter than a desired target pigmentation which would allow for higher light transmission than the desired outcome. To achieve that desired outcome, manufacturers adjust the pigmentation by processing the diffusers under high temperature conditions for several days, requiring greater energy expenditures during production and potentially requiring greater stores of inventory to compensate for the lengthy manufacturing process. A preferred embodiment of the present invention comprises a diffuser 50 containing no pigmentation. The material from which this diffuser 50 is manufactured may be any transmissive, diffusive material, such as but not limited to glass, vinyl, resin or plastic, and this material preferably is a Delrin® material. Omitting dies or pigments from the diffuser 50 allows for a transmission on the order of magnitude 200-400 times greater than that of a comparable, green-dye diffuser. The increase in light energy flowing through the pigment-free diffuser 50 enables incorporation of a smaller ASIC 40 than those required by sensors comprising green-dye diffusers. This decreased size of the ASIC 40 also leads to lower component costs and manufacturing costs as well because the high temperature pigment density adjustment process is unnecessary.

Incorporating a neutral density diffuser 50 lacking any pigment into the sensor 10 thus contributes to the broadband response characteristics of the sensor 10. (In a context of describing optical filters, the term “broadband” refers to filters that transmit a relatively broad spectral region within the passband without attenuation. This term also applies to sensors that respond to a broad spectral region of light wavelengths.) Returning to FIG. 2, in one embodiment of the present invention the external sensor cover, or transmissive layer 65, is fully transmissive and provides no significant spectral filtering of the incoming ambient light 20. The diffuser 50 is similarly transmissive and comprises a diffuse material providing no significant spectral filtering of the ambient light 20. The spectral response of the ASIC 40 thus primarily determines the spectral response of the sensor 10. The response of the ASIC 40 thus dominates the spectral response of this broadband configuration, and the sensor 10 experiences only a minor influence from the spectral transmission of the diffuser 50. The ASIC 40 produces an output signal 66 that interacts with a vehicle's control system 67 to accurately adjust the headlamps 68 and/or climate controls 69 accordingly.

In the embodiment of the present invention depicted in FIG. 2, a diffuser 50 in the form of a simple hemispherical dome produces a nearly uniform angular response from the ASIC 40. In another embodiment, the diffuser 50 may incorporate a vertical wall extending downward from the dome. Varying the vertical height of the dome alters the response characteristics of the sensor 10 when ambient light impinges from directly overhead. Decreasing a ratio of the diameter of the diffuser 50 to the wall height decreases the overhead diffusion, thereby lowering the peak angular response of the sensor 10. The new peak angular response may occur at a circular region many degrees away from a precise overhead point.

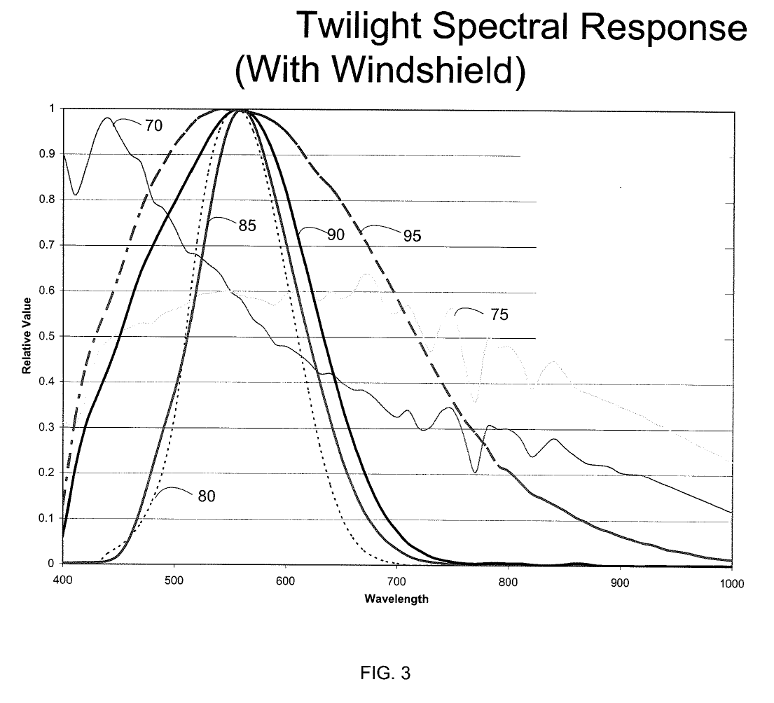

Turning now to FIGS. 3 through 5, characteristic response plots are mapped against various light wavelengths. These response curves correspond with the sensor 10 according to the present invention, an existing CIE sensor, a photodiode and a standard CIE curve. All of these plots are normalized for accurate comparison of relative signal output of each sensor type. Additionally, the CIE curve here is a photopic response curve that mathematically defines human eye perception of color under certain lighting conditions. The CIE curve thus represents a perception of luminance and chromaticity by the vehicle operator, as indicated by wavelength. Because human vision is most sensitive around green wavelengths, most sensor diffusers incorporate green dye to mimic a human eye response to varying light conditions, which may lead to inaccuracies in solar response. The present invention relies on the ASIC 40 to respond to varying light and solar loading conditions, thereby eliminating a need for such green dye and improving response accuracy.

FIG. 3 depicts various twilight spectral responses wherein perceived light energy values, such as those represented by lux or foot-candle measurements, are plotted against wavelength values. The first curve 70, peaks around 450 nm and depicts relative light intensity plotted against wavelengths of light for clear sky conditions. The second curve 75 is a relatively flat curve peaking at about 690 nm and depicting relative light intensity plotted against wavelengths of light under cloudy sky conditions. A standard CIE curve 80 centers on the visible light range and approximates human eye perception of ambient light. Clearly, the standard CIE curve 80 is relatively responsive over only a narrow range of visible light wavelengths, from approximately 400 nm to 700 nm because a human eye is most sensitive to these wavelengths.

Sensors comprising green dye diffusers accordingly respond to a range of wavelengths approximating this human eye CIE curve 80. FIG. 3 includes a green dye diffuser response curve 85 that depicts a relative perceived light energy value peaking at about the same wavelength as the CIE curve 80 and similarly having sensitivity ranging along wavelengths in the visible light region. The green dye diffuser response curve 85 therefore lacks sensitivity to wavelengths above the visible region, which are those wavelengths greater than approximately 700 nm. Those NIR wavelengths above 700 nm produce energy that heats an interior passenger compartment of a vehicle, but the green dye sensor, which produces the green dye diffuser response curve 85, fails to respond in that NIR region, thereby giving precedence to a vehicle's twilight function without accurately providing a solar load response. A photo transistor curve 90 demonstrates greater response to shorter wavelengths of light than the green dye diffuser curve 85, but still lacks response in the NIR range of the light spectrum.

In contrast to these curves, the sensor 10 of the present invention produces a broadband spectral response curve 95 having improved twilight and solar response sensitivity as compared to the existing sensors producing the green dye diffuser curve 85 and the phototransistor curve 90. As FIG. 3 depicts, the broadband spectral response curve 95 centers around wavelengths of 550 to 600 nm but also responds to light wavelengths below 400 nm and wavelengths above 700 nm and in the NIR region. This broadband response of the sensor 10 of the present invention thereby enables improved detector sensitivity under varying light conditions, such as localized fog that scatters light and that otherwise may trigger an undesirable solar response from sensors without such NIR wavelength sensitivity. The broadband sensor 10 thus provides more accurate solar control as compared to existing sensors, as depicted in FIG. 3.

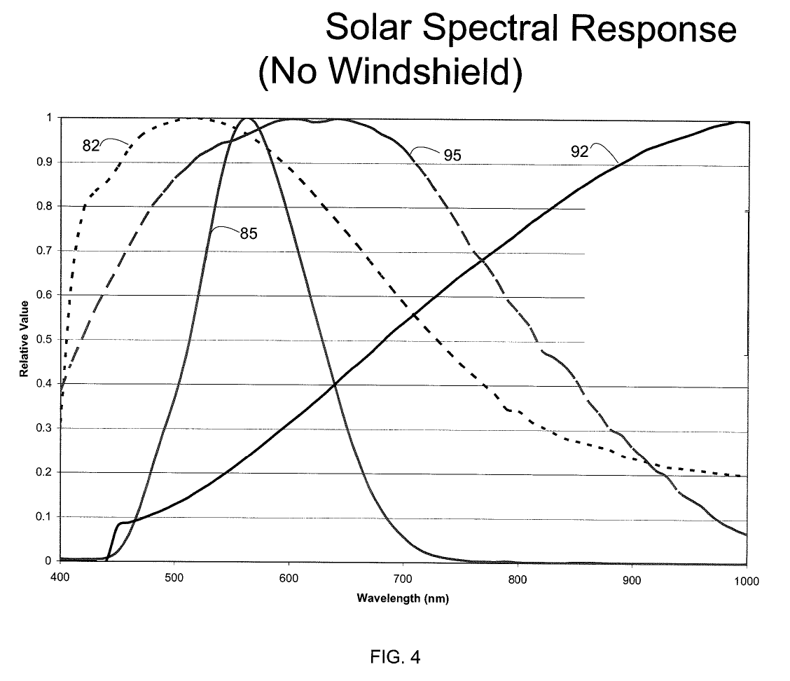

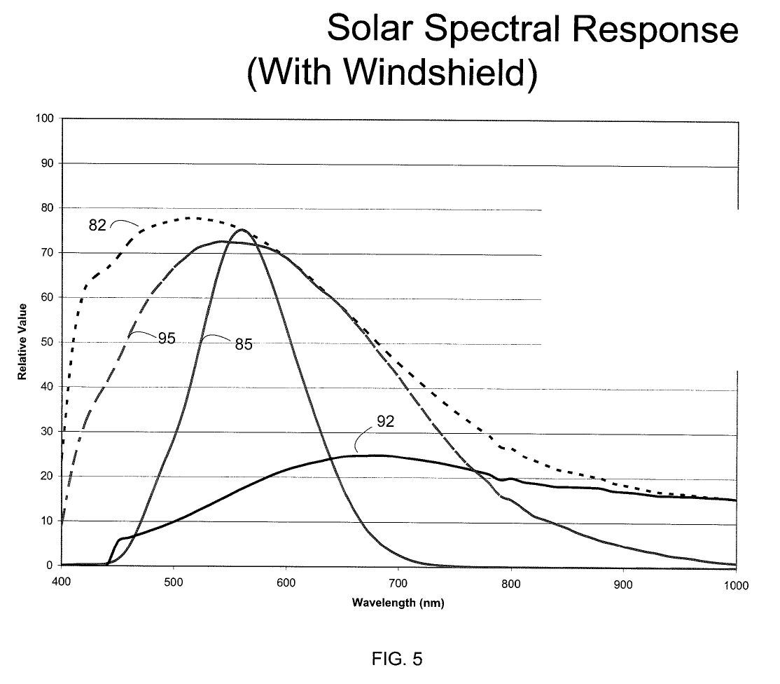

Taking FIGS. 4 and 5 together, the broadband sensor 10 of the present invention also better responds to solar loads heating a passenger compartment even with new windshield designs filtering NIR wavelengths. For consistency, sensor response curves are similarly numbered throughout FIGS. 3 through 5 according to a particular sensor type. The solar response curves in FIGS. 4 and 5 represent solar signals graphed against relative energy values measured in energy units, such as, for example, Watts per square meter (W/m²). FIG. 4 demonstrates solar spectral response curves for the various sensors under conditions of ambient light detected without a windshield, and FIG. 5 demonstrates solar spectral response curves for the same sensors under conditions of light passing through a windshield designed to filter out NIR wavelengths. Typical windshield transmissibility curve 82 provides a point of reference on both FIGS. 4 and 5.

These plots again demonstrate the highly sensitive broadband spectral response curve 95 of the sensor 10 of the present invention. In FIG. 4, a PN junction photodiode response curve 92 depicts a response well into NIR wavelengths and indicates a peak value between 900 nm and 1000 nm. This PN junction photodiode response curve 92, however, lacks sufficient sensitivity to respond in the visible light region, while the green dye diffuser curve 85, in contrast, responds well in the visible light region. The green dye diffuser curve 85, however, fails to respond to wavelengths beyond approximately 700 nm. This underscores the problems of existing sensors.

By comparison, the broadband spectral response curve 95 of the sensor 10 of the present invention provides a high level of sensitivity in a range of wavelengths extending from those shorter than 400 nm to those longer than 1000 nm. The sensor 10 thereby exhibits improved sensitivity over a broader range of wavelength as compared to other, existing sensors. Even with the addition of windshield attenuation of NIR wavelengths of light, the broadband spectral response curve 95 of the sensor 10 still remains sensitive to wavelengths ranging from those shorter than 400 nm to those well into the NIR wavelengths, up to about 1000 nm. FIG. 5 depicts this behavior in addition to depicting the effect of NIR attenuation upon a PN junction photodiode response curve 92. As shown here and in FIG. 4, the PN junction photodiode response curve 92 responds with great sensitivity in the NIR region, but loses sensitivity for accurately controlling solar load on a passenger compartment when new windshield designs prevent NIR wavelengths from reaching the PN junction photodiode sensor.

The ASIC 40 of the present invention achieves these outstanding broadband results by incorporating an integrated epi-photodiode 45 and a signal amplifier, and by providing signal outputs that correspond to photocurrent produced by varying intensities of shorter and longer wavelengths of detected light. In one embodiment of the present invention, the integrated epi-photodiode 45 and amplifier exist on a single die. In other embodiments, the sensor 10 of the present invention may comprise more than one die. While manufacturing an integrated photodetector and amplifier on the same die has many advantages, reasons also exist for producing two separate die that can be assembled together within the same sensor. One benefit of separating these two functions is the creation of a stacked die-on-die configuration. In such an arrangement, the photodiode die can be placed on top of the passivated amplifier die with the electrical connections made, for example, through simple wirebonds. If the amplifier die were much smaller than the photodiode, then the amplifier die could be on top, although a portion of the photodiode would be occluded. Alternately, the die could be arranged side-by-side. Any of these configurations are applicable for photodiodes fabricated using a bipolar process and amplifiers fabricated using a CMOS process, for example.

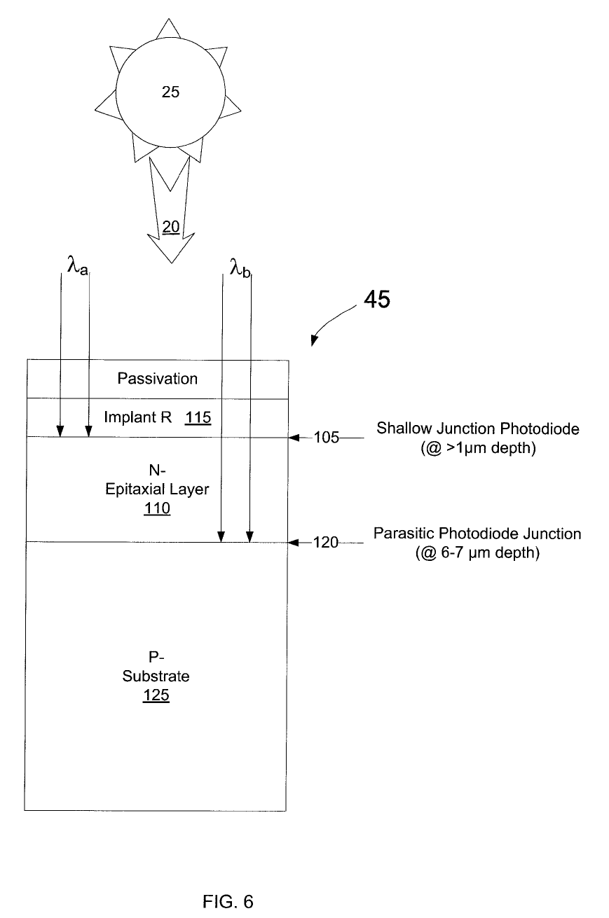

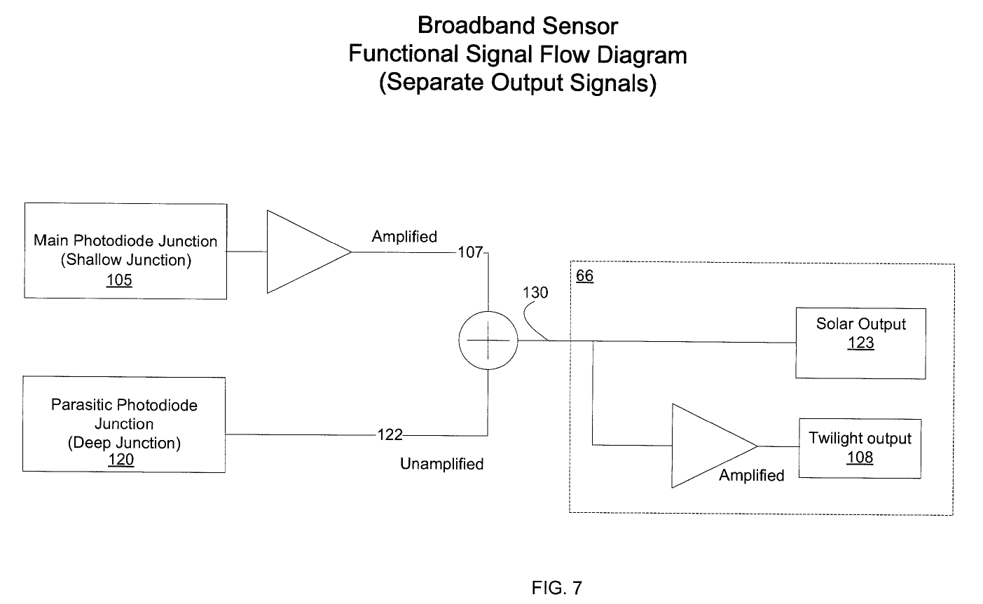

Turning now to FIGS. 6 and 7, FIG. 6 depicts layers in a schematic cross section of one embodiment the integrated epi-photodiode 45 of the ASIC 40. The integrated epi-photodiode 45 of the sensor 10 of the present invention comprises a main, or shallow, photodiode junction 105 disposed between an epitaxial N- layer 110 and an implant layer 115. The epi-photodiode 45 also comprises a deeper parasitic junction 120 disposed between a P- type substrate 125 and the N- epitaxial layer 110. In this exemplary embodiment, the shallow photodiode junction 105 occurs at a depth measured from the surface of the ASIC 40 up to about 1 micrometer. The parasitic photodiode junction 120 occurs beneath the shallow photodiode junction 105, and, in this embodiment, the parasitic photodiode junction 120 rests between 5 and 9 micrometers in depth as measured from the surface of the ASIC 40. In one embodiment, the parasitic photodiode junction 120 more specifically exists at a depth between 6 and 7 micrometers from the surface of the ASIC 40. This configuration contributes to the broadband response of the sensor 10. The shallow photodiode junction 105 produces photocurrent primarily in response to shorter wavelengths λa of ambient light 20. The deeper parasitic photodiode junction 120 responds to longer wavelengths λb of ambient light 20. The longer wavelengths λb penetrate deeper into the ASIC 40 and will reach the deeper parasitic photodiode junction 120.

As FIG. 7 shows in more detail, only the shallow photodiode current 107 produced at the shallow or main, photodiode junction 105 receives amplification. The parasitic photocurrent 122, produced by the deeper parasitic photodiode junction 120 receives no amplification and is extremely small (nA measurement range) as compared to the shallow photodiode current 107. The shallow photodiode junction 105 produces a current 107 that receives amplification. These two currents 107, 122 combine to produce output signals 108, 123 for controlling both solar functionalities and twilight functionalities in response to changing light levels. The ASIC 40 thus is spectrally sensitive to both the main, shallow photodiode current 107 and the deeper parasitic photodiode current 122.

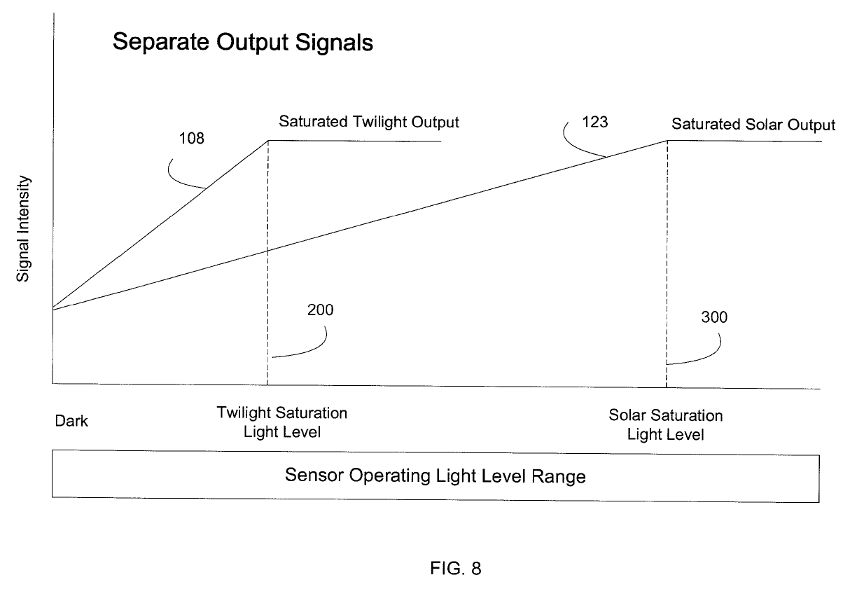

As FIGS. 7 and 8 further demonstrate, the solar output 123 and the twilight output 108 form a combined signal 130 which receives further treatment to produce the separate twilight output 108 and the solar output 123. As FIG. 7 further demonstrates, the solar output 123 is essentially equivalent to the combined signal 130, which comprises the amplified shallow photodiode current 107 and the unamplified parasitic photodiode current 122. The twilight output 108, however, is an amplified combined signal 130. The solar output 123 thus provides a response that is spectrally equivalent to that of the twilight output 108, and the amplified twilight output 108 enables a more sensitive sensor response to low light conditions. In some embodiments, the solar output 123 may receive some low gain amplification, but in that case, the magnitude of the solar amplification would remain small relative to the twilight amplification. As one skilled in the art would understand, the ratio of amplification applied to the solar output 123 versus the amplification applied to the twilight output 108 would be variable for use with specific applications.

Returning to the present embodiment, the amplified twilight output 108 thus creates a more sensitive sensor response to low light conditions, and the ASIC 40 provides an active twilight output 108 at relatively low intensity light levels. The sensor 10 of the present invention is thus sensitive enough to detect and respond to light of low luminance and intensity. In contrast to the twilight output 108, the solar output 123 is responsive to high intensity levels of ambient light 20. The solar output 123 is lower gain than the twilight output 108 and requires no, or very little, amplification for controlling solar functions, such as vehicle HVAC.

In the exemplary embodiment of FIGS. 7 and 8, the output signal 66 is a dual signal, comprising a twilight output 108 and a separate solar output 123 that separately control corresponding twilight and solar functions. The shallow photodiode junction 105 produces a shallow photodiode current 107 which signal receives amplification prior to producing the combined signal 130 by combining with the original, unamplified parasitic photocurrent 122 produced by the parasitic photodiode junction 120. The combined signal 130 separates into the solar output 123, which comprises the combined signal 130 with no further amplification, and the twilight output 108, which comprises an amplified combined signal 130. As FIG. 8 shows, both the twilight output 108 and the solar output 123 saturate as the intensity of ambient light 20 increases from darkness, but the twilight output 108 and solar output 123 vary and remain active within certain characteristic ranges. The twilight output 108, which is responsive in low light conditions such as sunrise and sunset, operates in a narrower light level range as compared to the solar output 123, which responds to higher intensity light levels. Accordingly, the twilight output 108 saturates at a lower light intensity level than the solar output 123, beyond which twilight saturation light level 200 twilight control is unnecessary.

For example, late day conditions typically comprise lower intensity ambient light 20 having wavelengths in the range of approximately 600-700 nm. The parasitic photocurrent 122, which results from longer wavelengths of light reaching the deeper parasitic junction 120, thus has a greater magnitude than the shallow photodiode current 107. As compared to a midday response, the combined signal 130 has a lower magnitude under the lower intensity ambient light 20 conditions at sunset. By comparison, at midday, high intensity, shorter wavelengths of light produce a shallow photodiode current 107 of substantial magnitude, which receives amplification and combines with the parasitic photocurrent 122 to produce a combined signal 130 of substantial magnitude. That large combined signal 130 saturates the twilight output 108 and continues to produce an active solar output 123. The twilight output 108, which results from further amplification of the combined signal 130, therefore creates a sensitive response to lower light levels that produce the smaller combined signal 130. Although the twilight output 108 saturates as light levels increase, the solar output 123 remains active in response to high intensity light levels that produce a higher combined signal 130.

As FIG. 8 depicts in detail, as the light level increases from the darkness, the twilight output 108 increases in a linear fashion until the twilight saturation light level 200 is reached. Beyond the twilight saturation light level 200 the twilight output 108 remains constant and no longer increases even though the light level increases. The solar signal 124, however, continues to increase as the light level increases until the solar saturation light level 300 is reached. Beyond the solar saturation light level 300 the solar output 123 remains constant and no longer increases even though the light level may continue to increase. It is important to understand that the twilight output 108 and the solar output 123 cease to latch once their saturation light levels 200, 300 are surpassed but will return to linear operation when the level of ambient light 20 falls below the respective saturation light levels 200, 300. The response of the sensor 10 thus is sensitive across a wide range of light levels.

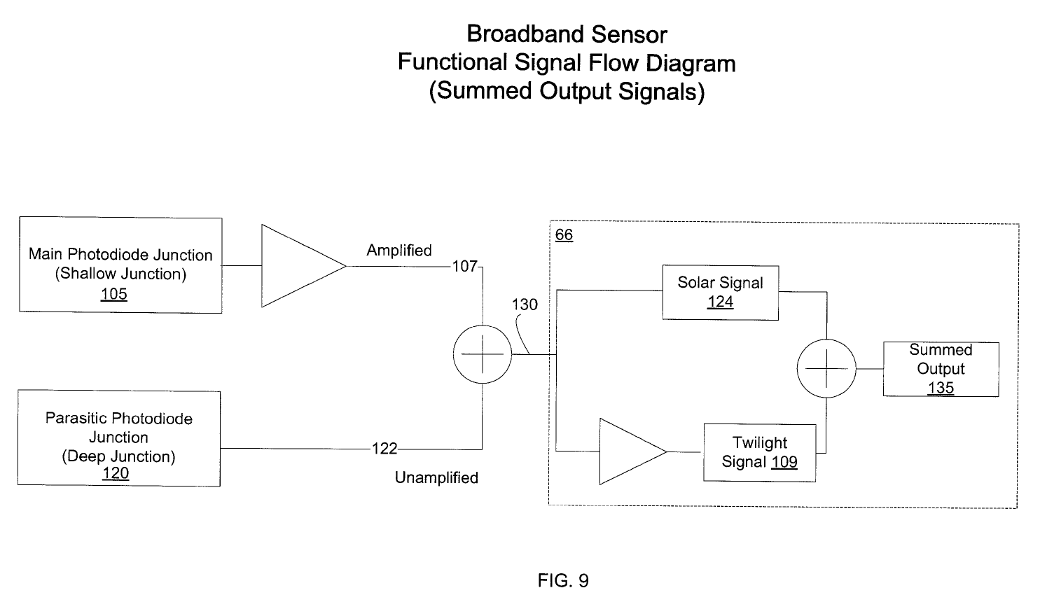

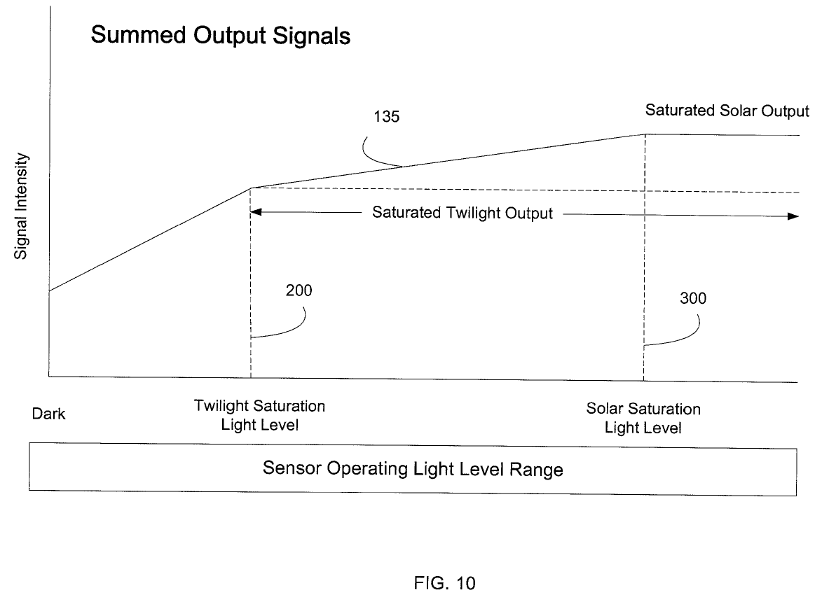

In another embodiment of the sensor 10 of the present invention, depicted in FIGS. 9 and 10, the twilight signal 109 and the solar signal 124 combine together to form a single summed output 135 that provides a single broadband response for controlling both solar and twilight functions. In this embodiment, while the light level falls within the twilight range, the magnitude of the summed output 135 is relatively low and activates twilight functions. When the light level intensifies and surpasses the twilight range, the twilight signal 109 saturates and remains unchanged while the single summed output 135 remains active and controls solar functions. As FIG. 10 depicts, as the light level increases from the darkness, the twilight signal 109 increases in a linear fashion until the twilight saturation light level 200 is reached. Beyond the twilight saturation light level 200 the twilight signal 109 remains constant and no longer increases even though the light level increases. The solar signal 124, however, continues to increase as the light level increases until the solar saturation light level 300 is reached. Beyond the solar saturation light level 300 the solar signal 124 remains constant and no longer increases even though the light level may continue to increase. It is important to understand that the twilight signal 109 and the solar signal 124 cease to latch once their saturation light levels 200, 300 are surpassed but will return to linear operation when the light level falls below the respective saturation light levels 200, 300.

In yet another embodiment, the sensor 10 of the present invention may be dual-zone or multi-zone such that the sensor 10 comprises more than one ASIC 40. In this embodiment, the sensor 10 comprises a plurality of ASICs 40 to provide more than one solar output 123. The twilight outputs 108 from all of the plurality of ASICs 40 are connected to provide a single combined twilight output 108 to enable a sensitive response to low light conditions.

In all embodiments, the shallow photodiode junction 105 and the parasitic photodiode junction 120 of the integrated epi-photodiode 45 thus work in concert to respond appropriately to the changing intensities of the shorter wavelengths λa and longer wavelengths λb of ambient light 20 impinging on the ASIC 40. The separate photodiode junctions are thus both continuously available to respond to changing lighting and light energy conditions, thereby controlling twilight and solar systems, such as the headlamps 68 and the climate controls 69 of a vehicle, in a responsive and accurate manner. The ASIC 40 of the sensor 10 of the present invention thereby provides a unique broadband spectral response that differs from those of commonly employed sensors, such as photodiodes, blue-enhanced photodiodes, UV-enhanced photodiodes, and cadmium-based photocells, which respond best to either twilight or solar load conditions rather than responding well to a broad range of ambient light and solar load conditions.

It is noted that the foregoing examples have been provided merely for the purpose of explanation and are in no way to be construed as limiting of the present invention. While the present invention has been described with reference to an exemplary embodiment, it is understood that the words, which have been used herein, are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

I claim:

1. A sensor that detects external ambient light energy for automatically controlling vehicle lighting and that detects solar loading within a vehicle passenger compartment for automatically controlling interior climate, wherein the sensor comprises:
a) an integrated circuit comprising a photodetector adapted for receiving ambient light energy and having a solar output signal and a twilight output signal that respond separately to received light energy,
i. wherein the solar output signal experiences a first gain and the twilight output signal experiences a second gain,
ii. wherein the solar output signal controls climate functions and the twilight output signal controls lighting functions, and
iii. wherein the spectral response of the sensor is dictated primarily by the spectral response of the photodetector;
b) a transmissive layer adapted to cover the sensor while providing no significant spectral filtering of the ambient light energy; and
c) a neutral density diffuser disposed between the transmissive layer and the integrated circuit wherein the diffuser lacks dyes or pigments for controlling the spectral response of the sensor and wherein the diffuser thereby allows light energy to reach the photodetector at an undiminished level of intensity.

2. The sensor of claim 1, further comprising an integrated signal amplifier.

3. The sensor of claim 1 wherein the photodetector is a photodiode.

4. The sensor of claim 1 further comprising a shallow P-N junction photodiode in the integrated circuit that responds to wavelengths of light in the visible range.

5. The sensor of claim 4 wherein the shallow P-N junction photodiode exists between the surface of the integrated circuit and a depth of 1 micrometer beneath the surface of the integrated circuit.

6. The sensor of claim 1 further comprising a parasitic P-N junction photodiode that responds to wavelengths of light from the end of the visible range through the NIR range.

7. The sensor of claim 6 wherein the parasitic P-N junction photodiode exists at a depth between 5 and 9 micrometers from the surface of the integrated circuit and more preferably exists at a depth of between 6 and 7 micrometers from the surface.

8. The sensor of claim 1 wherein the twilight output signal provides a spectral response including an eye-like response and wherein the solar output signal provides a spectral response to light wavelengths inclusive of those falling within the NIR spectral region.

9. The sensor of claim 1, further comprising a discrete signal amplifier.

10. The sensor of claim 9 wherein the integrated circuit comprising the photodetector is stacked with a second die comprising the discreet signal amplifier and wherein the integrated circuit and second die are electrically connected.

11. The sensor of claim 9 wherein the integrated circuit comprising the photodetector is disposed adjacent the second die comprising the discrete signal amplifier and wherein the integrated circuit and second die are electrically connected.

12. The sensor of claim 1 wherein the photodetector provides a solar response in direct relation to an amount of light energy entering and heating the vehicle passenger compartment.

13. The sensor of claim 1 wherein the sensor provides a spectral sensitivity in a range of about 350-1100 nm.

14. The sensor of claim 1 wherein the sensor operates in conjunction with improved windshield designs that attenuate ultraviolet (UV) and near infrared (NIR) energy that would otherwise reach the sensor.

15. The sensor of claim 14 wherein sensitivity of the sensor peaks at a wavelength of around 550 nm and wherein a sensor response curve approximates a windshield transmissibility curve.

16. The sensor of claim 1 wherein the diffuser is a simple hemispherical dome that provides ambient light to the sensor for producing a nearly uniform response at any angle of light incidence.

17. The sensor of claim 16 further comprising a vertical wall extending downward from the dome such that increasing or decreasing the diameter of the dome respectively decreases and increases a peak angular response of the sensor when the ambient light is directly over the sensor.

18. The sensor of claim 17 wherein increasing a ratio between a dome thickness and a wall height reduces the overhead response and respectively lowers the peak angular response of the sensor.

19. The sensor of claim 1, wherein the solar output signal and twilight output signal combine to produce a single output signal for controlling vehicle lighting and climate controls in response to varying intensities of ambient light.
